(19) United States
(12) Patent Application Publication
(10) Pub. No.: US 2026/0286694 A1
(43) Pub. Date: Sep. 24, 2026

(54) COMPOSITE STRUCTURE FOR BUILDING MATERIAL

(71) Applicant: Technology Innovation Institute - Sole Proprietorship LLC, Masdar City (AE)

(72) Inventors: Yossra ELKEBIR, Masdar City (AE); Mohamed Nasr SALEH, Masdar City (AE); Zhongwei GUAN, Masdar City (AE)

(73) Assignee: Technology Innovation Institute - Sole Proprietorship LLC, Masdar City (AE)

(21) Appl. No.: 19/575,543

(22) Filed: Mar. 23, 2026

Related U.S. Application Data
(60) Provisional application No. 63/776,523, filed on Mar. 24, 2025.

(51) Int. Cl. E04C 1/00

(52) U.S. Cl. CPC E04C 1/00

(57) ABSTRACT

A composite structure includes a fiber-based material, treated sand, and a polymeric binder material. The fiber-based material includes natural fibers. The polymeric binder material binds the fiber-based material and the treated sand. A bio-based brick can be manufactured from the composite structure.

### CROSS-REFERENCE TO RELATED APPLICATIONS

The present application claims the benefit of U.S. Provisional Patent Application No. 63/776,523 filed on Mar. 24, 2025, which is hereby incorporated by reference in its entirety.

### FIELD

The present disclosure relates to a composite structure, for example, a composite structure used to form a building material, such as a bio-brick.

### BACKGROUND

Concrete and clay brick building materials are employed in a variety of structural, decorative, and landscaping applications. The manufacturing of these materials, along with a cement binder to hold them together, can require the use of non-renewable natural resources (e.g., limestone, clay, and/or iron ore) and can produce significant levels of undesirable carbon dioxide (CO₂) emissions. In addition, the production of these materials can consume significant amounts of water, thereby exacerbating water scarcity and impacting biodiversity. Thus, the production of these materials can incur significant environmental impact.

### SUMMARY

Accordingly, there is a need for a durable building material made from renewable and/or repurposed materials that exhibits high structural integrity without relying on a cement-based binder. In particular, there is a need for a composite structure including readily-available natural materials and/or waste materials without requiring arduous processing and costly chemical treatments.

According to aspects, the composite structure may include a fiber-based material, treated sand, and a polymeric binder material that binds the fiber-based material and the treated sand. In aspects, the fiber-based material may include natural fibers.

According to aspects, a bio-based brick may be manufactured based on the composite structure. The bio-based brick may include a fiber-based material having one or more of palm fibers, wood waste, cork waste, bamboo waste, and agricultural waste. The fiber-based material may constitute greater than or equal to 1% and less than or equal to 60% of the composite structure by weight percentage. The bio-based brick may also include a silica filler that constitutes greater than or equal to 1% and less than or equal to 90% of the composite structure by weight percentage. The bio-based brick may further include a polymeric binder material having one or more of a resin, a vitrimer, a thermoset polymer, and a thermoplastic polymer. The polymeric binder material may constitute greater than or equal to 1% and less than or equal to 50% of the composite structure by weight percentage.

According to aspects, a method for manufacturing a bio-based brick may include mixing a fiber-based material and a silica filler to form a dry mixture, introducing the polymeric binder material into the dry mixture to form a wet mixture, and molding and/or curing the wet mixture to form the bio-based brick. The fiber-based material may include one or more of palm fibers, wood waste, cork waste, bamboo waste, and agricultural waste. The fiber-based material may constitute greater than or equal to 1% and less than or equal to 60% of the wet mixture by weight percentage. The silica filler may include one or more of river sand, sea sand, desert sand, quarry dust, and manufactured sand. The silica filler may constitute greater than or equal to 1% and less than or equal to 90% of the wet mixture by weight percentage. The polymeric binder material may include one or more of a resin, a vitrimer, a thermoset polymer, and a thermoplastic polymer. The polymeric binder material may constitute greater than or equal to 1% and less than or equal to 50% of the wet mixture by weight percentage.

### BRIEF DESCRIPTION OF THE DRAWINGS/FIGURES

The accompanying drawings, which are incorporated herein and form part of the specification, illustrate the present disclosure and, together with this written description, further serve to explain the principles of the present disclosure and to enable a person skilled in the relevant art(s) to make and use aspects described herein.

FIG. 1 shows a bio-based brick, according to aspects.

FIG. 2 shows a process flow for a method for manufacturing a composite structure, according to aspects.

FIG. 3 shows a process flow for a method for manufacturing a bio-based brick based on a composite structure, according to aspects.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Attempts have been made to find alternatives to concrete and clay bricks as building materials. Composite bricks, sustainable bricks, and polymer bricks (collectively, “eco bricks”) incorporate waste or recycled materials, often in the form of ash or slag, and to reduce or obviate the use of cement as a binder. However, such eco bricks may exhibit low structural integrity, meaning such eco bricks may not commercially replace concrete cement and clay bricks. Additional chemical treatments can be applied to eco bricks to create a more durable building component. However, such chemical treatments are expensive and may be affected by external factors, such as moisture, heat, and humidity levels. Thus, such chemical treatments may not be used in all environments.

Provided herein is a composite structure, which is environmentally-friendly and sustainably produced, and methods for providing the composite structure and a bio-brick formed from the composite structure. The composite structure provided herein forms the basis of building material articles having higher strength, lower water consumption, reduced CO₂ emissions, and comparable costs of production as compared to concrete cement and clay bricks.

This specification discloses one or more aspects that incorporate the features of the present disclosure. The disclosed aspect(s) are provided as examples. The scope of the present disclosure is not limited to the disclosed aspect(s). Claimed features are defined by the claims appended hereto.

The aspect(s) described, and references in the specification to “one aspect,” “an aspect,” “an example aspect,” etc., indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of one skilled in the art to effect such feature, structure, or characteristic in connection with other aspects whether or not explicitly described.

The terms “substantially,” “about,” “approximately,” or the like may be used herein to indicate a value of a quantity that may vary or be found to be within a range of values, based on a particular technology. As used herein, such terms may indicate a value of a given quantity that is exact or that is within a particular range, for example, within 1-20% of the value (e.g., +1%, +5%+10%, +15%, or +20% of the value). For example, the term “about 1 cm” indicates the value of 1 cm as well as the range of 0.8 cm to 1.2 cm.

### Composite Structure

A composite structure according to aspects includes a fiber-based material, a silica filler, and a polymeric binder. In aspects, the composite structure may also include one or more additives. Each of these components is discussed below.

According to aspects, the fiber-based material includes natural fibers. The natural fibers may a fibrous organic substance. For example, the natural fibers may include one or more of palm fibers, wood fibers, corks fibers, bamboo fibers, or leaf fibers. In aspects, the fiber-based material is a material that includes a thread-like structure, such as the filaments that form a vegetable tissue, a mineral tissue, or a textile. In some aspects, the natural fibers may constitute waste collected from one or more industrial or agricultural processes. For example, agricultural waste may be fibrous material, such as hay or wheat that is leftover from agricultural processes. In aspects, the natural fibers may include one or more of palm waste, wood waste, cork waste, bamboo waste, and agricultural waste. In at least one exemplary aspect, the fiber-based material includes palm fibers, which may include one or both of the fronds and the truck of the palm.

The natural fibers may be prepared by mechanical, chemical, and/or thermal processing. Mechanical processing may include grinding, polishing, sieving, powdering, pressing, roughening, and/or extruding processes. Chemical processing may include etching, distilling, oxidizing or reducing, hydrogenating or dehydrogenating, hydrating or dehydrating, catalyzing, polymerizing, alkalizing, acetylating, and/or silanating processes. Thermal processing may include burning, ashing, annealing, quenching, and/or conditioning processes. Combinations of mechanical processing, chemical processing, and thermal processing, such as hot pressing, cold grinding, and melt casting, may similarly be performed.

In aspects, collected natural fibers may be processed to create the fiber-based material. In aspects, collected natural fibers may be dried to reduce moisture content and then ground to reduce the size of the fibers into smaller, more uniform particles. In aspects, the dried fibers may be ground by one or more of hammer milling, ball milling, or knife milling. In at least one exemplary aspect, collected waste palm fibers may be dried at a temperature of 60-80° C. for 12-24 hours. The fibers may also be dried in a shorter time at a higher temperature of up to or above 100° C. in an industrial drying process. Alternatively, the fibers may be dried over a longer time at a lower temperature by drying the fibers in natural sunlight.

According to aspects, the natural fibers may also be subjected to one or more chemical treatments. In aspects, the natural fibers may be cleaned to remove contaminants. For example, the natural fibers may be placed in a solution including one or both of acetone and ethanol and then washed with distilled water. In aspects, the natural fibers may be subjected to one or more of an alkaline treatment, a silane treatment, and an acetylation treatment. For example, in an alkaline treatment, the natural fibers may be subjected to an initial Mercerization NaOH treatment, and then to one or more additional alkaline treatments by exposing the natural fibers to dissolved NaOH. Such alkaline treatment(s) achieves partial solubilization of lignin in the natural fibers and hemicelluloses, which enhances adhesion of the natural fibers, thereby improving the mechanical properties and durability of the composite structure. As a silane treatment, the natural fibers may be soaked in a solution containing one or more silane coupling agents, including aminosilanes, vinylsilanes, and epoxysilanes, to thereby enhance the compatibility of the natural fibers with a polymer. And, during acetylation, the natural fibers may be exposed to an acetic anhydride to break down fiber bundles into finer fibrils, thereby enhancing interfacial bonding.

In at least one exemplary aspect, waste palm fibers may undergo an alkaline treatment in about 5% alkaline solution of NaOH in distilled water at 80° C. for 1.5 hours before rinsing with distilled water. The alkaline-treated waste palm fibers may then undergo a silane treatment in a 0.5-3% silane solution for 1-4 hours at room temperature before drying in an over at 80-100° C. for 2-6 hours. The silane-treated waste palm fibers may finally undergo acetylation by exposure to acetic anhydride at 120-130° C. for 1-2 hours, followed by steam treatment at 160-220° C. for 5-15 minutes.

According to aspects, the natural fibers are prepared to have an average particle diameter that is less than or equal to about 1 mm, less than or equal to about 500 μm, and less than or equal to about 300 μm. In aspects, the natural fibers may include waste palm fibers that have been processed to have an average particle diameter that is less than or equal to about 300 μm. In aspects, the size and accuracy required in the resulting average particle diameter of the natural fibers may be based on the expected use of the composite structure. For example, it may be sufficient to process the natural fibers to have an average particle diameter that is less than or equal to about 1 mm within an accuracy of about 20% (e.g., an average particle diameter in a range of about 0.8 mm to about 1.2 mm). In aspects, the average particle diameter may be equal to about 300 μm within an accuracy of about 1% (e.g., an average particle diameter of about 297 μm to about 303 μm). Processing the natural fibers in this way may ensure that the natural fibers include sufficient surface area to allow bonding by a binder material and thus sufficient structural integrity for the expected use.

According to aspects, the fiber-based material may be provided in an amount to include more than or equal to about 1% and less than or equal to about 60% of the composite structure by weight percentage. That is, the fiber-based material may include about 1 wt.-% to about 60 wt.-% (inclusive of 1 wt.-% and 60 wt.-%) of the composite structure. In aspects, the fiber-based material may include greater than or equal to about 5% and less than or equal to about 20% of the composite structure by weight percentage. In aspects, the physical properties of the composite structure are sensitive to the amount of fiber-based material. For example, as shown in Tables 1 and 2 below, the density, compression strength, and flexural strength of the composite structure may vary as the amount of the fiber-based material increases. As utilized herein, when the content of a component in the composite structure is disclosed in terms of weight percentage (wt.-%), the amount of the component disclosed refers to the amount of the component present in the wet mixture utilized to form the composite structure. By way of illustration, a composite structure that is disclosed to include 15 wt.-% of a fiber-based material was formed from a wet mixture that contained 15 wt.-% of the fiber-based material.

According to aspects, the silica filler provides additional strength, porosity, flexibility, and/or any other desired or predetermined mechanical characteristics to the composite structure. In aspects, the silica filler includes sand, pulverized rocks, quarry dust, or a combination thereof. In aspects, the silica filler may include sand, such as river sand, sea sand, desert sand, manufactured sand, or a combination thereof. In aspects, the silica filler may include treated sand. For example, the silica filler may include sand that has been treated by one or more of mechanical processing, chemical processing, and thermal processing. In aspects, sand may be obtained from a natural source (e.g., a river, sea, or desert) and chemically treated, for example, by a NaOH treatment, to reduce or eliminate water and impurities. In aspects, sand may be processed to avoid impurities. As used herein, the term “treated sand” refers to sand that has undergone one or more of mechanical processing, chemical processing, and thermal processing.

In aspects, the silica filler including treated sand may be obtained by exposing collected sand to one or more processing steps. In aspects, collected sand may be cleaned with a solvent and dried. In aspects, collected sand may be subjected to an alkaline treatment, such as the alkaline treatment described above, to remove organic contaminants and increase surface roughness. In aspects, collected sand may be subjected to an acid treatment, for example, using solutions of one or more of hydrochloric acid to dissolve calcium impurities and sulfuric acid to enhance surface activation of the sand. In at least one exemplary aspect, collected sand may be cleaned in a solution of acetone and ethanol at 80° C. for 5 hours, then washed with distilled water. The cleaned sand may then be subjected to alkaline treatment in a 1-5% NaOH solution for 30 minutes up to 2 hours, before being washed and dried. The sand may then be soaked in 1-5% hydrochloric acid and/or 1-3% sulfuric acid for 30 minutes up to 2 hours each, before washing and drying to obtain treated sand according to some aspects.

According to aspects, the silica filler may be mechanically processed to produce treated sand with grains having an average particle diameter of less than or equal to about 2 mm, less than or equal to about 1 mm, less than or equal to about 500 μm, and less than or equal to about 100 μm. For example, the silica filler may be sieved to have an average particle diameter of less than or equal to about 100 μm. In at least one exemplary aspect, the silica filler may be treated sand that is sieved to have an average particle diameter that is less than or equal to about 100 μm.

In aspects, the size and accuracy required in the resulting average particle diameter of the silica filler may be based on the expected use of the composite structure. For example, the silica filler may be processed to have an average particle diameter that is about equal to the average particle diameter of the natural fibers. According to aspects, the silica filler may be processed to have an average particle diameter that is substantially smaller than the average particle diameter of the waste fibers. Processing the silica filler in this way may ensure that the silica filler is able to fill in gaps between grains of the natural fibers. In addition, processing the silica filler in this way may ensure optimal consistency and integration within the composite structure, to enhance the structural integrity and performance of the composite structure. Furthermore, such processing also reduces stress factors in the composite structure arising from larger diameter particles in the silica filler.

According to aspects, the silica filler may be provided in an amount to include greater than or equal to about 1% and less than or equal to about 90% of the composite structure by weight percentage. That is, the silica filler may include about 1 wt.-% to about 90 wt.-% (inclusive of 1 wt.-% and 90 wt.-%) of the composite structure. In aspects, the silica filler may include greater than or equal to about 50% and less than or equal to about 65% of the composite structure by weight percentage. In aspects, the physical properties of the composite structure are highly sensitive to the amount of silica filler.

According to aspects, the polymeric binder is a non-cement based organic binder. For example, the binder may be a resin, a thermoset polymer, a thermoplastic polymer, a vitrimer, or a combination thereof. Examples of thermoset resins according to aspects include RESOLTECH© 1070 ECO and 1070(S) and Easycomposite© IN2 and IB2. Examples of thermoplastic resins according to aspects include a polyamide water based formulation and a polyetheretherketone (PEEK) water based formulation.

According to aspects, the polymeric binder may be provided in an amount to include more than or equal to about 1% and less than or equal to about 50% of the composite structure by weight percentage. That is, the polymeric binder may include about 1 wt.-% to about 50 wt.-% (inclusive of 1 wt.-% and 50 wt.-%) of the composite structure. In aspects, the polymeric binder may include about 25% of the composite structure by weight percentage. In aspects, the physical properties of the composite structure are sensitive to the amount of polymeric binder. For example, if the composite structure is too high in polymeric binder (by wt.-%), the composite structure may lack structural integrity and thus exhibit low compressive and flexural strength. However, if the composite structure is too low in polymeric binder (by wt.-%), the silica filler and fiber-based material may not adequately be bound together, and thus the composite structure may exhibit low compressive and flexural strength.

According to aspects, the composite structure may also include one or more additives. In aspects, the composite structure may include one or more additives to improve one or more of a mineral property, a chemical property, an ultraviolet resistance property, a thermal insulation property, and a porosity of the composite structure. For example, a dye can be added to provide a desired color. A coarse granular material can be added to provide a desired and/or predetermined texture. Such additives can include mineral additives, chemical additives, recycled additives, ultraviolet (UV) light resistant additives, thermally insulating additives, pore-filling additives, plasticizers, curing accelerators, coupling agents, flame retardants, hydrophobic agents, antimicrobial agents, acoustic insulation additives, or any combination thereof. For example, in aspects, polystyrene beads may be added for thermal insulation. In aspects, pigments or dyes may be added to change a color of the composite structure. In at least one exemplary aspect, an additive of a pigment may be added in liquid or powder form at 1-4 wt-% of the composite structure without any effect on the non-color properties of the composite structure.

### Building Material Article and Bio-Based Bricks

According to aspects, the composite structure may be formed into a building material article. A building material article may be formed by preparing a mixture including the above described components of a composite structure, and then shaping or molding and curing the mixture to form a building material article.

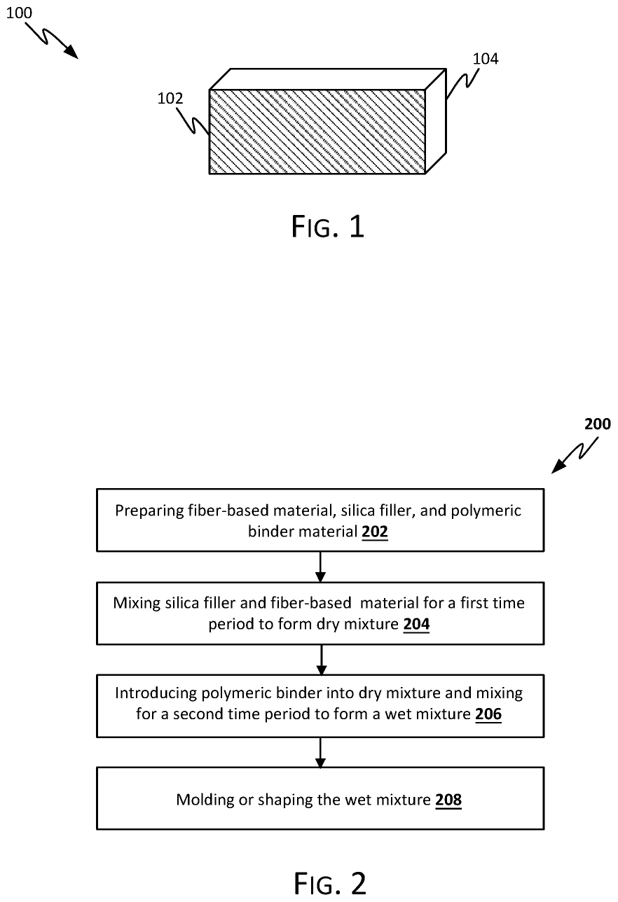

In aspects, a building material article can be a structural article, a decorative article, or a decorative structural article. For example, a building material article can be a brick, a paver, a block, a hardscape article, an ornamental landscape article, a foundational landscape article, a foundational building article, a fence post foundation, a fencing article, a facade, an artificial stone, or any suitable building material article. FIG. 1 depicts a diagram of a sample building material article configured as a bio-based brick 100, according to aspects. In aspects, bio-based brick 100 can include a face 102 and a frame structure 104, providing a hollow brick having a facade. In aspects, bio-based brick 100 can be a hollow brick, including frame structure 104 and faces 102 covering all sides of building material article 100.

In aspects, bio-based brick 100 can be solid (e.g., non-porous), porous, an empty frame, or any suitable structure. In aspects, bio-based brick 100 can be compacted by having air removed during production. In aspects, bio-based brick 100 can have a predetermined degree of porosity.

In aspects, the building material article may have one or more physical properties that is advantageous for use as a building material. For example, a building material article according to aspects may have a lower density than comparative examples (e.g. Comparative Examples 1 and 2 in Tables 1-3 below), rendering it useful as a substitute for the comparative example. As shown below, a building material article including the composite structure according to aspects herein may have a lower density, improved mechanical properties, and improved water uptake properties with respect to comparative examples.

TABLE 1
Composition and Density

| | Formulation of Composite Structure | | | |
|---|---|---|---|---|
| | Fiber-based | Binder | Filler/Additives | Density |
| Sample | Material (wt.-%) | (wt.-%) | (wt.-%) | (g/cm³) |
| Comparative | concrete cement | | | 2.14 |
| Example 1 | | | | |
| Comparative | 0 | 25 | 75 | 1.67 |
| Example 2 | | | | |
| Sample 1 | 10 | 25 | 65 | 1.55 |
| Sample 2 | 15 | 25 | 60 | 1.56 |
| Sample 3 | 20 | 25 | 55 | 1.40 |

Table 1 compares the densities of building material articles formed of several composite structures. Comparative Example 1 is a building material article prepared from concrete cement. Comparative Example 2 is a building material article that includes a green epoxy binder and sand as a filler. Samples 1-3 are building material articles that each include a fiber-based material of waste palm fibers, a polymeric binder material made of a mixture of RESOLTECH© 1070 ECO and 1074 ECO epoxies, and a treated sand filler, according to aspects. Each of Samples 1-3 and Comparative Examples 1 and 2 was manufactured according to concrete standard EN 196, the European standards for testing cement. As shown in Table 1, Samples 1-3 each has a density lower than that of concrete cement (Comparative Example 1). In addition, the inclusion of waste palm fibers as a fiber-based material results in a lower density than that of Comparative Example 2, which includes only a binder and sand. Lower density bricks are easier for handling and transportation, thereby reducing shipping costs, safer to use during construction in case of accidents, and require fewer workers to properly place during construction, thereby saving labor costs. Thus, according to aspects, substituting the fiber-based material in place of filler may lower the density of the resulting building material article.

TABLE 2
Mechanical Properties

| | Compression Strength (MPa) | | Flexural Strength (MPa) | |
|---|---|---|---|---|
| Sample | 2 days | 28 days | 2 days | 28 days |
| Comparative | 20.0 ± 5.0 | 35.2 ± 6.6 | 3.8 ± 0.5 | 7.9 ± 0.3 |
| Example 1 | | | | |
| Comparative | 73.3 ± 2.6 | 78.4 ± 5.1 | 25.3 ± 0.6 | 28.1 ± 1.3 |
| Example 2 | | | | |
| Sample 1 | 74.3 ± 2.5 | 76.9 ± 2.8 | 28.3 ± 2.7 | 33.3 ± 3.3 |
| Sample 2 | 57.7 ± 7.5 | 60.6 ± 13.0 | 20.9 ± 2.3 | 20.1 ± 3.6 |
| Sample 3 | 37.5 ± 5.8 | 28.4 ± 8 | 14.2 ± 1.7 | 8.6 ± 1.3 |

Table 2 compares the compression strength and the flexural strength of the building material articles shown in Table 1. Compression tests and flexure tests were performed according to the EN 196 standard and are reported in Mega Pascal (MPa) units of pressure. In particular, flexure testing was performed by placing the sample building material article in a testing machine with a flat side disposed on supporting rollers separated by a distance of 100 mm±0.5 mm. A vertical load was applied by a loading roller and increased gradually at a rate of 50±10 Newtons per second (N/s) until the building material article fractured. The applied pressure (in MPa) was determined based on the applied load at failure. After the flexure test was completed, a portion of the building material article was positioned between two hardened steel plates, and a compressive force was applied to the sample by the plates. The load was gradually and uniformly increased at a rate of 2400±200 N/s until the portion of the building material article fractured. The applied pressure (in MPa) was determined based on the applied load at failure. In accordance with the EN 196 standard, data is shown in Table 2 for measurements taken 2 days after manufacture (while the building material articles were still curing) and 28 days after manufacture (when the building material articles were fully cured).

As shown in Table 2, Samples 1-3 each displayed compressive and flexural strengths to be useful as a building material article. For example, Samples 1-3 each displayed compressive and flexural strengths similar to or greater than concrete cement (Comparative Example 1), and thus could be used as substitute building material articles in cases where concrete cement is used. Moreover, Samples 1 and 2 each has higher compressive and flexural strength than concrete cement (Comparative Example 1), both after 2 days and after 28 days. Sample 1 also has compressive and flexural strength consistent (within the margin of error) with that of Comparative Example 2, both after 2 days and after 28 days, despite having a lower density (see Table 1 above). A higher strength building material, as shown by higher failure pressures in Table 2, leads to better (stronger) building materials, which can be used in more diverse applications. In addition, higher strength building materials are able to achieve the same safety factor while using less material, thereby saving material costs during construction. Thus, the addition of a fiber-based material, according to aspects, may lower the density of the composite structure without substantially affecting the compressive and flexural strength of the resulting building material article.

TABLE 3
Water Uptake

| | Water Uptake after 7 days | Water Uptake after 28 days |
|---|---|---|
| Sample | (%) | (%) |
| Comparative | 4.6 ± 1.0 | 4.7 ± 0.9 |
| Example 1 | | |
| Comparative | 0.3 ± 0.03 | 0.6 ± 0.04 |
| Example 2 | | |
| Sample 1 | 0.6 ± 0.1 | 1.5 ± 0.03 |
| Sample 2 | 5.7 ± 1.6 | 8.2 ± 2.6 |
| Sample 3 | 16.2 ± 1.0 | 23.5 ± 2.7 |

Table 3 compares the water uptake of the building material articles shown in Table 1. The water uptake measurements were performed at 7 days and 28 days according to the EN 196-1 standard. Dried building material articles were weighed to obtain the unsaturated weight (W_{dry}) and then completely submerged in water at room temperature for the specified period of time shown in Table 3 (i.e., 7 days or 28 days). After the specified period, the samples were removed from the water and excess surface water was drained. Samples were immediately weighed to obtain the saturated weight (W_{wet}). The water uptake (absorption) was then calculated using the formula:

$$Water Uptake ( \% ) = \frac{{W}_{wet} - {W}_{dry}}{{W}_{dry}} \times 100 .$$

As shown in Table 3, the water uptake of the building material article of Sample 3 is substantially higher than that of the other Samples and Comparative Examples. Such a high water uptake renders the building material article of Sample 3 suitable for building material articles in drier locations, such as deserts, where the building material article is unlikely to be exposed to moisture either in the form of liquid water (e.g., rain) or evaporated water (e.g., humidity). In addition, the building material articles of Sample 2 is suitable for relatively less dry locations, where it is likely only to be exposed to evaporated water (e.g., humidity). Moreover, the water uptake of the building material article of Sample 1 is lower than that of concrete cement (Comparative Example 1), rendering it suitable as a building material article in most locations around the world. Given the very low water uptake of Sample 1, the building material article of Sample 1 is suitable as a replacement for concrete cement where the concrete cement is regularly or continually exposed to liquid water (e.g., as support for marine structures, bridges, etc.).

TABLE 4
Thermal Properties

| | Thermal Conductivity | Thermal Resistance |
|---|---|---|
| Sample | (W/m · K) | (m² · K/W) |
| Sample 4 | 0.29 | 0.16 |
| Sample 5 | 0.34 | 0.13 |
| Sample 6 | 0.40 | 0.11 |
| Average of Samples 4-6 | 0.34 | 0.13 |

Table 4 compares thermal insulation properties of building material articles formed of several composite structures. Samples 4-6 are building material articles that each include the same formulation of a fiber-based material of waste palm fibers, a polymeric binder material made of a mixture of epoxies and a treated sand filler, according to aspects. According to aspects, the mixture of epoxies can be a mixture of a high-gloss epoxy (e.g., RESOLTECH 1070 ECO) and an epoxy hardener (e.g., RESOLTECH 1074 ECO). Each of Samples 4-6 was manufactured according to concrete standard EN 196 (the European standards for testing cement) and each had an average thickness of approximately 45-50 mm (e.g., 47 mm). The thermal conductivity and thermal resistance measurements were performed using a heat flow meter in accordance with ASTM C518-17. Thermal conductivity values were measured directly, and thermal resistance values were calculated based on the measured thickness and thermal conductivity.

As shown in Table 4, Samples 4-6 each demonstrated a thermal conductivity substantially lower than values of concrete cement (e.g., 1.4-1.75 W/m·K) and concrete mortar (e.g., 0.72-1.00 W/m·K), and averaged approximately 0.35 W/m. K. These measurement values indicate that building material articles formed from the composite structures herein demonstrate improved thermal insulation performance as compared to cement-based construction materials. The corresponding thermal resistance values (averaging approximately 0.14 m²·K/W) demonstrate the suitability of building material articles formed from the composite structures herein for applications where thermal insulation is desired, such as building envelopes, wall systems, and insulation blocks.

The combination of low thermal conductivity with the mechanical performance described in Tables 1-4 above allows building material articles formed from the composite structures herein to provide both structural functionality and thermal insulation, reducing the need for additional insulation layers in certain construction applications.

According to aspects, improved thermal insulation performance may be achieved without compromising the compressive and flexural strengths of the building material article. As demonstrated by the results in Tables 2 and 4, building material articles formed from the composite structures herein achieve a balance between mechanical strength and thermal insulation, while maintaining a reduced density compared to traditional concrete-based materials, providing material savings, improved energy efficiency of buildings, and reduced overall construction costs.

The reduced thermal conductivity of the composite structures enables improved thermal insulation, which is advantageous for insulation building applications, particularly in warmer climates. Improved thermal resistance may reduce heat transfer through walls, contributing to enhanced energy efficiency of buildings and reduced cooling energy demand.

Table 5 compares fire resistance properties of the samples shown in Table 4. Fire reaction and resistance properties were evaluated using fire testing methods. For example, heat release rate (HRR) and maximum average rate of heat emission (MARHE) were tested using a cone calorimeter according to ISO 5660-1. Glow-Wire Ignition μOxygen Index (LOI) testing was performed according to ISO 4589-2. Values for each of these properties for cement-based materials are also provided in Table 5, for ease of comparison.

TABLE 5
Fire Resistance Properties

| | HRR | MARHE | GWIT | LOI |
|---|---|---|---|---|
| Property | (kW/m²) | (kW/m²) | (° C.) | (%) |
| Sample 4 | 43.2 | 61.5 | >950 | 28.5 |
| Sample 5 | 49.5 | 58.2 | >950 | 28.3 |
| Sample 6 | 39.9 | 66.8 | >950 | 28.5 |
| Average of Samples 4-6 | 44.2 | 62.2 | >950 | 28.37 |
| Value of Cement-based | 80-250 | >100 | 650-800 | 20-23 |
| Materials | | | | |

As shown in Table 5, Samples 4-6 exhibited an average HRR of 44.2 kW/m² and an average MARHE value of 62.2 kW/m², which indicate fire-resistant behavior for construction applications. These values indicate a low contribution of fire growth relative to cement-based materials. In addition, GWIT testing showed no ignition of Samples 4-6 at temperatures up to 950° C., showing that the ignition temperature of Samples 4-6 is higher than 950° C. and thus indicates a high resistance to ignition when exposed to localized high-temperature heat sources. Moreover, Samples 4-6 demonstrated an average LOI value of 28.37%. This value is above the values of approximately 25-26%, which can be associated with slow-burning or self-extinguishing behavior. The relatively higher measured LOI of Samples 4-6 is significantly higher than that of wood-based materials and polymeric materials, indicating reduced flammability of the building material articles formed from the composite structures herein.

The results shown in Table 5 demonstrate that building material articles formed from the composite structures herein exhibit an improved fire reaction profile characterized by low heat release, high resistance to ignition, and slow combustion behavior. When considered together with the mechanical properties shown in Table 2 and the thermal properties shown in Table 4, the building material articles formed from the composite structures herein provide a multifunctional building material suitable for construction applications requiring structural performance, thermal insulation, and enhanced fire safety.

### Method of Manufacture

FIG. 2 shows a process flow of an exemplary manufacturing process 200 for a method of manufacturing a building material article by preparing a composite structure, according to aspects. The process of FIG. 2 is an example, and more or fewer operations may be performed. In aspects, the fiber-based material, silica filler, and polymeric binder may be mixed in a single operation, or in separate operations taking place over substantial time periods, for example, separated by days, weeks, months, or even years. As an example, a dry mixture described below may be prepared but stored and not mixed with the polymeric binder to form the wet mixture until a later time.

At operation 202, a fiber-based material, a silica filler, and a polymeric binder are prepared, according to aspects. The fiber-based material, silica filler, and polymeric binder may be prepared according to the physical, chemical, and thermal processing steps described above. In aspects, preparing the fiber-based material may include one or more of drying the collected natural fibers, cleaning the collected natural fibers, performing one or more of an alkali treatment (e.g., to clean and improve surface characteristics), a silane treatment (e.g., to increase water repellency), and an acetylation process (e.g., to reduce hydrophilicity) on the collected natural fibers to adjust physical and/or chemical properties of the fiber-based material, and rinsing the natural fibers. In aspects, preparing the fiber-based material includes processing waste palm fibers to have an average particle diameter that is less than or equal to about 1 mm, less than or equal to about 500 μm, and less than or equal to about 300 μm.

Preparing the silica filler may include performing one or more of mechanical processing, chemical processing, and thermal processing, as described above. In aspects, preparing the silica filler may include treating one or more of river sand, sea sand, desert sand, manufactured sand, and a combination thereof, to form treated sand. According to aspects, preparing the silica filler includes processing the silica filler to acquire grains having an average particle diameter of less than or equal to about 2 mm, less than or equal to about 1 mm, less than or equal to about 500 μm, and less than or equal to about 100 μm. In aspects, preparing the silica filler includes sieving sand to achieve an average particle diameter of less than or equal to about 100 μm.

Preparing the polymeric binder may include performing one or more of mechanical processing, chemical processing, and thermal processing, as described above. According to aspects, preparing the polymeric binder includes preparing one or more non-cement based organic binders. In aspects, preparing the polymeric binder may include preparing a resin, a thermoset polymer, a thermoplastic polymer, a vitrimer, or a combination thereof. For example, preparing the polymeric binder may include heating the polymeric binder to a specified temperature to ensure fluidity of the binder.

At operation 204, the fiber-based material and the silica filler are mixed to form a dry mixture. The fiber-based material and the silica filler may be mixed in a mortar mixer, a continuous mixer, a drum mixer, a paddle mixer, a pan mixer, or any suitable mixing device. The fiber-based material and the silica filler are mixed for a first time period that is greater than or equal to 10 seconds and less than or equal to 5 minutes. For example, the first time period may be 1 minute.

At operation 206, the polymeric binder is introduced into the dry mixture to form a wet mixture. In some aspects, the wet mixture may include the components of the composite structure as discussed above. The polymeric binder may be introduced all at one, or may be added over time. The mixing of the wet mixture continues for a second time period. The second time period may be greater than or equal to 10 seconds and less than or equal to 5 minutes. For example, in at least one exemplary aspect, the second time period may be 1 minute.

At 208, after mixing the wet mixture for the second time period, the wet mixture may molded and/or cured, as discussed below in detail. In some aspects, the wet mixture may be cured in the mold. In some aspects, the wet mixture may be cured after being removed from the mold.

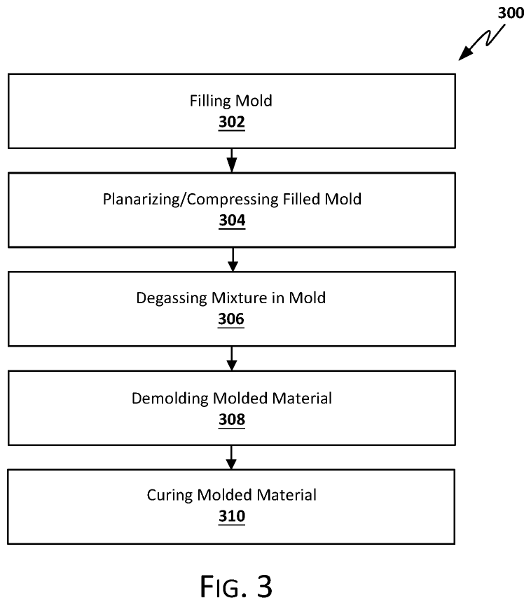

FIG. 3 shows a process flow for an exemplary manufacturing process 300 for a method of forming a building material article, according to aspects. The process of FIG. 3 is an example, and more or fewer operations may be performed.

At operation 302, a wet mixture prepared according to manufacturing process 200 is placed into a mold, according to aspects. The wet mixture may be poured, injected, or filled into the mold. Operation 302 can be performed by manual filling, mechanical filling, vibration filling, or any suitable filling process. According to aspects, the mold can have a shape suitable for forming a building material article having a desired shape after curing. For example, the mold can include structural and/or aesthetic attributes. The mold can have a shape that produces molded articles with a block shape, an interlocking block shape, a paver shape, an ornamental curb shape, an interlocking fence shape, or any suitable shape for the expected purpose of the resulting building material article. In aspects, the building material article may include ornamental elements.

At operation 304, the wet mixture may be planarized to the top of the mold and/or compressed into the mold, according to aspects. For example, after filling operation 302, any of the wet mixture extending above an upper rim of the mold can be removed, providing a flat surface in the wet mixture consistent with the top of the mold. In aspects, the wet mixture can be pressed into the mold to completely fill all voids in the mold, remove air pockets, and/or at least partially cure the wet mixture. If desirable, compression can be performed for up to about 1 minute, for example, by performing 1 minute of continuous compression, or by performing 30 seconds of compression, a release, and an additional 30 seconds of compression, or any compression duration optimal for the wet mixture. In aspects, the mold filled with the wet mixture may be vibrated to settle the wet mixture within the mold. For example, the filled mold may be placed on a vibration table and vibrated for up to about 3 minutes.

At operation 306, the wet mixture may be degassed to remove a predetermined amount of air from the wet mixture. The wet mixture may be fully degassed to remove pores and provide a high-density building material article. According to aspects, the degassing operation 306 can be performed as desired to provide a predetermined porosity, a structural characteristic (e.g., water absorptivity, flexibility, and density), and/or an aesthetic aspect.

In applications in which low-density building material articles are preferable, the wet mixture may not be degassed. In some aspects, the wet mixture may be degassed by being poured or filled into the mold.

At operation 308, the molded building material article is removed from the mold (e.g., demolded), according to aspects.

At operation 310, the molded building material article is cured. During curing, the polymeric binder is undergoing a chemical transformation that binds the fiber-based material to the silica filler. In aspects, curing operation 310 is performed in a controlled environment (e.g., temperature, humidity, and/or air flow can be controlled to provide consistent curing). For example, curing operation 310 may be performed at room temperature or at a higher temperature. In aspects, curing operation 310 is performed according to the curing requirements of the binder. For example, for an epoxy-based binder, the wet mixture may be demolded after 4 hours curing at room temperature, or may be cured for 1-3 hours at an elevated temperature such as 60-80° C. A polyester binder may be cured for 1-4 hours at room temperature, or for 30 minutes at an elevated temperature such as 60-80° C. For the polyamide based binder formulations discussed above, consolidation can happen in 30 minutes to 2 hours at temperatures of 50-100° C. following molding at temperatures of 180-240° C. and cooling.

Additional aspects can be found in one or more of the following clauses:
1. A composite structure includes a fiber-based material, treated sand, and a polymeric binder material to bind the fiber-based material and the treated sand. The fiber-based material includes natural fibers.
2. The composite structure of clause 1, where the natural fibers include one or more of palm fibers, wood fibers, cork fibers, bamboo fibers, and agricultural waste.
3. The composite structure of clauses 1 and 2, where the natural fibers include palm fibers having an average particle diameter of less than or equal to about 300 μm.
4 The composite structure of clauses 1 to 3, where the polymeric binder material includes one or more of a resin, a thermoset polymer, a thermoplastic polymer, and a vitrimer.
5. The composite structure of clauses 1 to 4, where the treated sand includes one or more of river sand, sea sand, desert sand, quarry dust, and manufactured sand, and the treated sand has an average particle diameter of less than or equal to 1 cm.
6. The composite structure of clauses 1 to 5, where the treated sand includes desert sand having an average particle diameter that is less than or equal to 100 μm.
7. The composite structure of clauses 1 to 6 further includes one or more additives including a dye, a coarse granular material, a mineral additive, a chemical additive, a recycled additive, an ultraviolet (UV) light resistant additive, a thermally insulating additive, a pore-filling additive, a plasticizer, a curing accelerator, a coupling agent, a flame retardant, a hydrophobic agent, an antimicrobial agent, an acoustic insulation additive, and a combination thereof.
8. The composite structure of clauses 1 to 7, where the treated sand includes greater than or equal to 1% and less than or equal to 90% of the composite structure by weight percentage.
9. The composite structure of clauses 1 to 8, where the fiber-based material includes greater than or equal to 1% and less than or equal to 60% of the composite structure by weight percentage.
10. The composite structure of clauses 1 to 9, where the polymeric binder material includes greater than or equal to 1% and less than or equal to 50% of the composite structure by weight percentage.
11. The composite structure of clauses 1 to 10, where the polymeric binder material constitutes 25% of the composite structure by weight percentage, the fiber-based material constitutes 10% the composite structure by weight percentage, and a remaining weight of the composite structure includes one or more of the treated sand and an additive.
12. The composite structure of clauses 1 to 10, where the polymeric binder material constitutes 25% of the composite structure by weight percentage, the fiber-based material constitutes 15% the composite structure by weight percentage, and a remaining weight of the composite structure includes one or more of the treated sand and an additive.
13. The composite structure of clauses 1 to 10, where the polymeric binder material constitutes 25% of the composite structure by weight percentage, the fiber-based material constitutes 20% the composite structure by weight percentage, and a remaining weight of the composite structure includes one or more of the treated sand and an additive.
14. The composite structure of clauses 1 to 13, where the composite structure is in the form of a brick
15. A bio-based brick formed from a composite structure. The bio-based brick includes a fiber-based material, a silica filler, and a polymeric binder material. The fiber-based material includes one or more of palm fibers, wood fibers, cork fibers, bamboo fibers, and agricultural waste. The fiber-based material constitutes greater than or equal to 1% and less than or equal to 60% of the composite structure by weight percentage. The silica filler constitutes more than or equal to 1% and less than or equal to 90% of the composite structure by weight percentage. The polymeric binder material includes one or more of a resin, a vitrimer, a thermoset polymer, and a thermoplastic polymer. The polymeric binder material constitutes greater than or equal to 1% and less than or equal to 50% of the composite structure by weight percentage.
16. The bio-based brick of clause 15, where the fiber-based material constitutes greater than or equal to 1% and less than or equal to 20% of the composite structure by weight percentage, the polymeric binder material constitutes 25% of the composite structure by weight percentage, and a remaining weight of the composite structure includes one or more of the silicon filler and an additive.
17. The bio-based brick of clauses 15 and 16, where the fiber-based material includes palm fibers having an average particle diameter that is less than or equal to about 300 μm, and the silica filler includes desert sand having an average particle diameter that is less than or equal to about 100 μm.
18. A method for manufacturing a bio-based brick includes mixing a fiber-based material and a silica filler to form a dry mixture, introducing a polymeric binder material into the dry mixture to form a wet mixture, and molding and/or curing the wet mixture to form the bio-based brick. The fiber-based material includes one or more of palm fibers, wood fibers, cork fibers, bamboo fibers, and agricultural waste. The silica filler includes one or more of river sand, sea sand, desert sand, quarry dust, and manufactured sand. The polymeric binder material includes one or more of a resin, a vitrimer, a thermoset polymer, and a thermoplastic polymer. The fiber-based material constitutes greater than or equal to 1% and less than or equal to 60% of the wet mixture by weight percentage. The silica filler constitutes greater than or equal to 1% and less than or equal to 90% of the wet mixture by weight percentage. The polymeric binder material constitutes greater than or equal to 1% and less than or equal to 50% of the wet mixture by weight percentage.
19. The method for manufacturing a bio-based brick of clause 18 further includes, prior to mixing the fiber-based material and the silica filler to form the dry mixture, preparing the fiber-based material by chemically treating palm fibers to one or more of an alkali treatment, a silane treatment, and an acetylation process.
20. The method for manufacturing a bio-based brick of clauses 18 and 19 further includes, prior to mixing the fiber-based material and the silica filler to form the dry mixture, preparing the silica filler by sieving desert sand to have an average particle diameter that is less than or equal to 100 μm.

It is to be understood that the phraseology or terminology herein is for the purpose of description and not of limitation, such that the terminology or phraseology of the present disclosure is to be interpreted by those skilled in relevant art(s) in light of the teachings herein.

It is to be appreciated that the Detailed Description section, and not the Summary and Abstract sections, is intended to be used to interpret the claims. The Summary and Abstract sections may set forth one or more but not all exemplary aspects of the present disclosure as contemplated by the inventor(s), and thus, are not intended to limit the present disclosure and the appended claims in any way.

The breadth and scope of the protected subject matter should not be limited by any of the above-described exemplary aspects, but should be defined only in accordance with the following claims and their equivalents.

What is claimed is:

1. A composite structure, comprising:
a fiber-based material comprising natural fibers;
treated sand; and
a polymeric binder material that binds the fiber-based material and the treated sand.

2. The composite structure of claim 1, wherein the natural fibers comprise one or more of palm fibers, wood fibers, cork fibers, bamboo fibers, and agricultural waste.

3. The composite structure of claim 2, wherein the natural fibers comprise palm fibers having an average particle diameter of less than or equal to 300 μm.

4. The composite structure of claim 1, wherein the polymeric binder material comprises one or more of a resin, a thermoset polymer, a thermoplastic polymer, and a vitrimer.

5. The composite structure of claim 1, wherein:
the treated sand comprises one or more of river sand, sea sand, desert sand, quarry dust, and manufactured sand; and
the treated sand has an average particle diameter of less than or equal to 1 mm.

6. The composite structure of claim 5, wherein the treated sand comprises desert sand having an average particle diameter that is less than or equal to 100 μm.

7. The composite structure of claim 1, further comprising:
one or more additives comprising a dye, a coarse granular material, a mineral additive, a chemical additive, a recycled additive, an ultraviolet (UV) light resistant additive, a thermally insulating additive, a pore-filling additive, a plasticizer, a curing accelerator, a coupling agent, a flame retardant, a hydrophobic agent, an antimicrobial agent, an acoustic insulation additive, and a combination thereof.

8. The composite structure of claim 1, wherein the treated sand comprises greater than or equal to 1% and less than or equal to 90% of the composite structure by weight percentage.

9. The composite structure of claim 1, wherein the fiber-based material comprises greater than or equal to 1% and less than or equal to 60% of the composite structure by weight percentage.

10. The composite structure of claim 1, wherein the polymeric binder material comprises greater than or equal to 1% and less than or equal to 50% of the composite structure by weight percentage.

11. The composite structure of claim 1, wherein:
the polymeric binder material comprises 25% of the composite structure by weight percentage;
the fiber-based material comprises 10% the composite structure by weight percentage; and
a remaining weight of the composite structure comprises one or more of the treated sand and an additive.

12. The composite structure of claim 1, wherein:
the polymeric binder material comprises 25% of the composite structure by weight percentage;
the fiber-based material comprises 15% the composite structure by weight percentage; and
a remaining weight of the composite structure comprises one or more of the treated sand and an additive.

13. The composite structure of claim 1, wherein:
the polymeric binder material comprises 25% of the composite structure by weight percentage;
the fiber-based material comprises 20% the composite structure by weight percentage; and
a remaining weight of the composite structure comprises one or more of the treated sand and an additive.

14. The composite structure of claim 1, wherein the composite structure is in the form of a brick.

15. A bio-based brick comprising a composite structure, the composite structure comprising:
a fiber-based material comprising one or more of palm fibers, wood fibers, cork fibers, bamboo fibers, and agricultural waste, wherein the fiber-based material comprises greater than or equal to 1% and less than or equal to 60% of the composite structure by weight percentage;
a silica filler comprising more than or equal to 1% and less than or equal to 90% of the composite structure by weight percentage; and
a polymeric binder material comprising one or more of a resin, a vitrimer, a thermoset polymer, and a thermoplastic polymer, wherein the polymeric binder material comprises greater than or equal to 1% and less than or equal to 50% of the composite structure by weight percentage.

16. The bio-based brick of claim 15, wherein:
the fiber-based material comprises greater than or equal to 1% and less than or equal to 20% of the composite structure by weight percentage;
the polymeric binder material comprises 25% of the composite structure by weight percentage; and
a remaining weight of the bio-based brick comprises one or of more of the silica filler and an additive.

17. The bio-based brick of claim 15, wherein:
the fiber-based material comprises palm fibers having an average particle diameter that is less than or equal to about 300 μm; and
the silica filler comprises desert sand having an average particle diameter that is less than or equal to about 100 μm.

18. A method for manufacturing a bio-based brick, comprising:
mixing a fiber-based material and a silica filler to form a dry mixture, wherein the fiber-based material comprises one or more of palm fibers, wood fibers, cork fibers, bamboo fibers, and agricultural waste, and wherein the silica filler comprises one or more of river sand, sea sand, desert sand, quarry dust, and manufactured sand;
introducing a polymeric binder material into the dry mixture to form a wet mixture, wherein the polymeric binder material comprises one or more of a resin, a vitrimer, a thermoset polymer, and a thermoplastic polymer; and
molding and/or curing the wet mixture to form the bio-based brick, wherein:
the fiber-based material comprises greater than or equal to 1% and less than or equal to 60% of the wet mixture by weight percentage;
the silica filler comprises greater than or equal to 1% and less than or equal to 90% of the wet mixture by weight percentage; and
the polymeric binder material comprises greater than or equal to 1% and less than or equal to 50% of the wet mixture by weight percentage.

19. The method of claim 18, further comprising:
prior to mixing the fiber-based material and the silica filler to form the dry mixture, preparing the fiber-based material by chemically treating palm fibers to one or more of an alkali treatment, a silane treatment, and an acetylation process.

20. The method of claim 18, further comprising:
prior to mixing the fiber-based material and the silica filler to form the dry mixture, preparing the silica filler by sieving desert sand to have an average particle diameter that is less than or equal to about 100 μm.
